(19) United States
(12) Patent Application Publication
(10) Pub. No.: US 2026/0008889 A1
(43) Pub. Date: Jan. 8, 2026

(54) POLYAMIC ACID COMPOSITION, POLYIMIDE, POLYIMIDE FILM, LAMINATE, ELECTRONIC DEVICE, METHOD OF PRODUCING POLYIMIDE, METHOD OF PRODUCING LAMINATE, AND METHOD OF PRODUCING ELECTRONIC DEVICE

(71) Applicant: KANEKA CORPORATION, Osaka (JP)

(72) Inventors: Nobuaki Tanaka, Otsu-shi (JP); Yusuke Fukuzaki, Otsu-shi (JP); Hirofumi Nakayama, Otsu-shi (JP)

(73) Assignee: KANEKA CORPORATION, Osaka (JP)

(21) Appl. No.: 19/327,281

(22) Filed: Sep. 12, 2025

Related U.S. Application Data
(63) Continuation of application No. PCT/JP2024/008814, filed on Mar. 7, 2024.

(30) Foreign Application Priority Data
Mar. 14, 2023 (JP) 2023-039466
Jan. 9, 2024 (JP) 2024-001173

(51) Int. Cl. C08G 73/10; C08J 5/18

(52) U.S. Cl. CPC C08G 73/1071; C08G 73/1032; C08G 73/1042; C08G 73/1053; C08J 5/18; C08J 2379/08

(57) ABSTRACT

The polyamic acid composition contains a polyamic acid and an organic solvent. The polyamic acid has a tetracarboxylic dianhydride residue and a diamine residue. The tetracarboxylic dianhydride residue includes a 3,3′,4,4′-biphenyltetracarboxylic dianhydride residue and a spiro[11H-difuro[3,4-b:3′,4′-i]xanthene-11,9′-[9H]fluorene]-1,3,7,9-tetrone residue. The diamine residue includes a p-phenylenediamine residue. At least one of the tetracarboxylic dianhydride residue or the diamine residue further includes a residue having an ester bond. At least one of the tetracarboxylic dianhydride residue or the diamine residue further includes a residue having a diphenyl ether structure.

### TECHNICAL FIELD

One or more embodiments of the present invention relate to a polyamic acid composition, a polyimide, a polyimide film, a laminate, an electronic device, a method of producing a polyimide, a method of producing a laminate, and a method of producing an electronic device. One or more embodiments of the present invention further relate to an electronic device material in which a polyimide is used, a thin film transistor (TFT) substrate, a flexible display substrate, a color filter, a printed matter, an optical material, an image display device (more specifically, a liquid crystal display device, an organic EL, or an electronic paper), a 3D display, a solar cell, a touch panel, a transparent conductive film substrate, and an alternative material for a member in which glass is currently used.

### BACKGROUND

With rapid progress of displays such as liquid crystal displays, organic electro-luminescence (organic ELs), and electronic papers and electronic devices such as solar cells and touch panels, devices have been progressively made thinner, lighter, and more flexible. In these devices, a polyimide is used as a substrate material instead of a glass substrate.

In these devices, various electronic elements such as a thin film transistor and a transparent electrode are formed on a substrate, and formation of these electronic elements needs a high-temperature process. A polyimide has heat resistance sufficient to be adaptable to a high-temperature process, and has a linear thermal expansion coefficient (CTE) close to that of a glass substrate or an electronic element, so that internal stress is less likely to occur. Thus, a polyimide is suitable for a substrate material for a flexible display and the like.

A polyimide obtained from a polyamic acid composition containing a polyamic acid and an organic solvent is used not only as a substitute for a glass substrate of an electronic device, an insulating film used in a semiconductor device, a protective coating agent, and the like, but also as a planarization film for a TFT substrate for a display device (see, for example, Patent Document 1). It is known that planarization films for TFT substrates use a material such as an acrylic resin, a siloxane, or a photosensitive polyimide (see, for example, Patent Document 2 and Patent Document 3).

### PATENT DOCUMENTS

Patent Document 1: JP 2021-34578 A
Patent Document 2: JP 2006-178436 A
Patent Document 3: JP 2022-34533 A

### SUMMARY

In organic EL display devices and semiconductor devices, the process temperature recently may be high for a reason such as an increase in size of a substrate and improvement in productivity, and there is room for further improvement in heat resistance of existing insulating films and planarization films. In a high-temperature process, the adhesion between a polyimide film and an inorganic oxide film provided on a substrate may deteriorate.

A polyamic acid composition may be stored for a while in a state of a solution in a coating apparatus such as a slit coater or a spin coater. If the viscosity of a polyamic acid composition changes during storage in a coating apparatus, a smooth coating film having a uniform thickness may be difficult to obtain. Therefore, a polyamic acid composition excellent in storage stability is desired.

It is difficult to obtain a polyamic acid composition that enables production of a polyimide excellent in heat resistance and adhesion to an inorganic oxide film while achieving excellent storage stability using only the techniques described in Patent Documents 1 to 3.

One or more embodiments of the present invention have been achieved in view of the above circumstances, and a polyamic acid composition that enables production of a polyimide excellent in heat resistance and adhesion to an inorganic oxide film while achieving excellent storage stability is provided. A polyimide, a polyimide film, a laminate, and an electronic device that are produced using the polyamic acid composition are also provided. Furthermore, a method of producing a polyimide, a method of producing a laminate, and a method of producing an electronic device, using the polyamic acid composition are provided.

### Aspects of the Invention

An aspect of one or more embodiments of the present invention is as follows.

[1] A polyamic acid composition including a polyamic acid and an organic solvent,
the polyamic acid having a tetracarboxylic dianhydride residue and a diamine residue,
the tetracarboxylic dianhydride residue including a 3,3′,4,4′-biphenyltetracarboxylic dianhydride residue and a spiro[11H-difuro[3,4-b:3′,4′-i]xanthene-11,9′-[9H]fluorene]-1,3,7,9-tetrone residue,
the diamine residue including a p-phenylenediamine residue, in which
at least one of the tetracarboxylic dianhydride residue or the diamine residue further includes a residue having an ester bond, and
at least one of the tetracarboxylic dianhydride residue or the diamine residue further includes a residue having a diphenyl ether structure.

[2] The polyamic acid composition according to [1], having a content of the spiro[11H-difuro[3,4-b:3′,4′-i]xanthene-11,9′-[9H]fluorene]-1,3,7,9-tetrone residue of 10 mol % or less with respect to a total amount of the tetracarboxylic dianhydride residue included in the polyamic acid.

[3] The polyamic acid composition according to [1] or [2], in which the tetracarboxylic dianhydride residue includes, as the residue having an ester bond, one or more selected from the group consisting of tetravalent organic groups represented by General Formula (1) described below and a tetravalent organic group represented by Chemical Formula (2) described below:

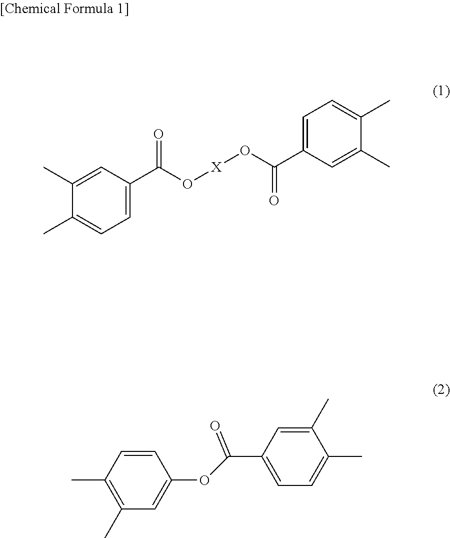

in which X represents a divalent organic group represented by General Formula (3) described below, a divalent organic group represented by General Formula (4) described below, a divalent organic group represented by General Formula (5) described below, a divalent organic group represented by Chemical Formula (6) described below, or a divalent organic group represented by Chemical Formula (7) described below:

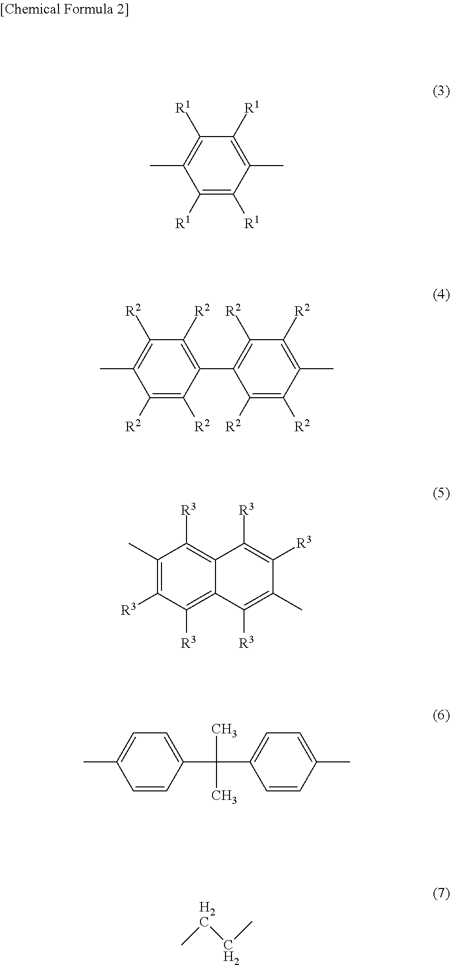

in which R¹, R², and R³ each independently represent a hydrogen atom, a methyl group, an ethyl group, or a trifluoromethyl group, a plurality of R¹s are optionally equal to or different from each other, a plurality of R²s are optionally equal to or different from each other, and a plurality of R³s are optionally equal to or different from each other.

[4] The polyamic acid composition according to any one of [1] to [3], in which the diamine residue includes, as the residue having an ester bond, one or more selected from the group consisting of a divalent organic group represented by Chemical Formula (8) described below, divalent organic groups represented by General Formula (9) described below, and divalent organic groups represented by General Formula (10) described below:

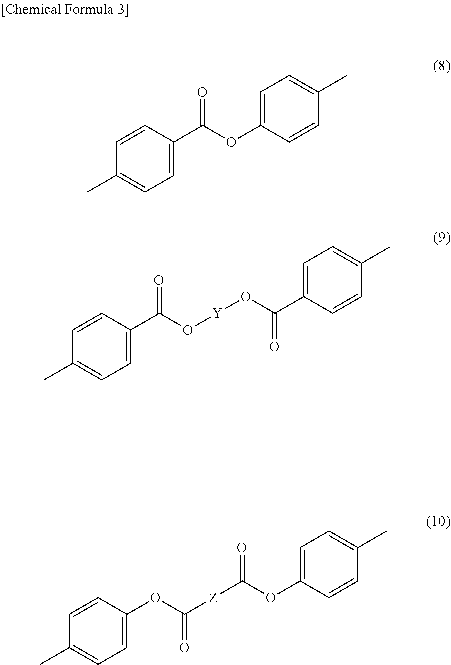

in which Y and Z each independently represent a divalent organic group represented by General Formula (11) described below, a divalent organic group represented by General Formula (12) described below, or a divalent organic group represented by General Formula (13) described below:

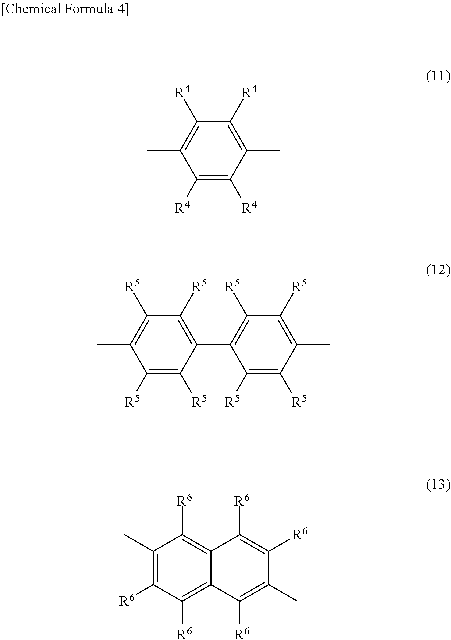

in which R⁴, R, and R⁶ each independently represent a hydrogen atom, a methyl group, an ethyl group, or a trifluoromethyl group, a plurality of R⁴s are optionally equal to or different from each other, a plurality of R⁵s are optionally equal to or different from each other, and a plurality of R⁶s are optionally equal to or different from each other.

[5] The polyamic acid composition according to any one of [1] to [4], in which the tetracarboxylic dianhydride residue includes a 4,4′-oxydiphthalic anhydride residue as the residue having a diphenyl ether structure.

[6] The polyamic acid composition according to any one of [1] to [5], in which the diamine residue includes a 4,4′-oxydianiline residue as the residue having a diphenyl ether structure.

[7] The polyamic acid composition according to [4], in which the diamine residue includes the divalent organic group represented by Chemical Formula (8) as the residue having an ester bond.

[8] The polyamic acid composition according to any one of [1] to [7], having a viscosity change ratio within ±20% when stored for 14 days in an environment at a temperature of 23° C. and a relative humidity of 55%.

[9] The polyamic acid composition according to any one of [1] to [8] in which the organic solvent contains a compound represented by General Formula (14) described below:

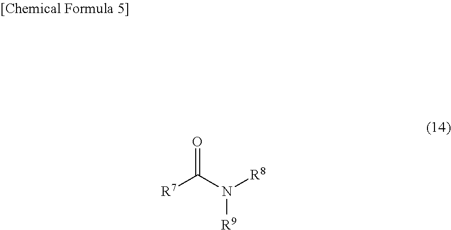

in which R⁷, R⁸, and R⁹ each independently represent a monovalent organic group having 1 or more carbon atoms or represent a hydrogen atom, and at least one of R⁷, R¹, or R⁹ represents a monovalent organic group having 2 or more carbon atoms.

[10] A polyimide being an imidized product of the polyamic acid contained in the polyamic acid composition according to any one of [1] to [9].

[11] The polyimide according to [10], having a 1% weight loss temperature of 450° C. or higher.

[12] A polyimide film including the polyimide according to [10] or [11].

[13] A laminate including a support and the polyimide film according to [12].

[14] The laminate according to [13], further including an inorganic oxide film interposed between the support and the polyimide film, in which
a peel strength between the polyimide film and the inorganic oxide film is 0.10 N/cm or more.

[15] An electronic device including the polyimide film according to [12] and an electronic element disposed on the polyimide film.

[16] A method of producing a polyimide, the method including imidizing the polyamic acid contained in the polyamic acid composition according to any one of [1] to [9].

[17] A method of producing a laminate including a support and a polyimide film, the method including
applying the polyamic acid composition according to any one of [1] to [9] onto a support to form a coating film containing the polyamic acid and heating the coating film to imidize the polyamic acid.

[18] A method of producing an electronic device, the method including
forming a laminate including a support and a polyimide film with the method according to [17], and forming an electronic element on the polyimide film.

According to one or more embodiments of the present invention, it is possible to provide a polyamic acid composition that enables production of a polyimide excellent in heat resistance and adhesion to an inorganic oxide film while achieving excellent storage stability. According to one or more embodiments of the present invention, it is also possible to provide a polyimide, a polyimide film, a laminate, and an electronic device that are produced using the polyamic acid composition. Furthermore, according to one or more embodiments of the present invention, it is also possible to provide a method of producing a polyimide, a method of producing a laminate, and a method of producing an electronic device, using the polyamic acid composition.

### DETAILED DESCRIPTION

One or more embodiments of the present invention will be described in detail below, but one or more embodiments of the present invention are not limited to these embodiments. The academic documents and the patent documents mentioned in the present description are incorporated in the present description by reference in their entirety.

First, terms used in the present description will be described. The term “structural unit” refers to a repeating unit included in a polymer. The term “polyamic acid” refers to a polymer including a structural unit represented by General Formula (15) described below (hereinafter, sometimes described as “structural unit (15)”).

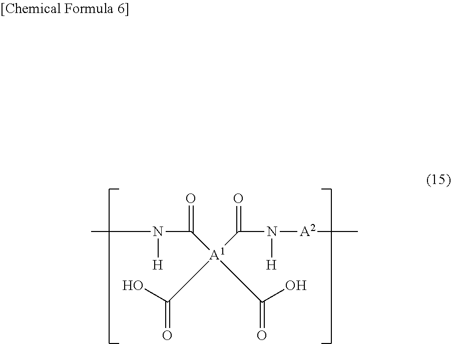

In General Formula (15), A¹ represents a tetracarboxylic dianhydride residue (tetravalent organic group derived from a tetracarboxylic dianhydride), and A² represents a diamine residue (divalent organic group derived from a diamine).

The content of the structural unit (15) with respect to all of the structural units included in the polyamic acid may be, for example, 50 mol % or more and 100 mol % or less, 60 mol % or more and 100 mol % or less, 70 mol % or more and 100 mol % or less, 80 mol % or more and 100 mol % or less, or 90 mol % or more and 100 mol % or less, and may be 100 mol %.

The term “1% weight loss temperature” refers to a measurement temperature when the weight of a polyimide is decreased by 1 wt %0 with respect to the reference weight (100 wt %) that is the weight of the polyimide at a measurement temperature of 150° C. The method of measuring the 1% weight loss temperature is the same as or similar to the method in Examples described below.

The “linear thermal expansion coefficient” is a coefficient of linear thermal expansion during a temperature decrease in the range from 100° C. to 300° C., unless otherwise specified.

Hereinafter, the name of a compound may be followed by the term “-based” to collectively refer to the compound and its derivatives. The term “-based” following the name of a compound to express the name of a polymer means that repeating units of the polymer are derived from the compound or its derivative, unless otherwise specified. The tetracarboxylic dianhydride may be described as “acid dianhydride.”

The components, the functional groups, and the like shown in the present description may be used singly or in combination of two or more kinds thereof, unless otherwise specified.

### One or More Embodiments of Present Invention

The polyamic acid composition according to one or more embodiments contains the polyamic acid (hereinafter, sometimes described as “polyamic acid (1)”) and an organic solvent. The polyamic acid (1) has a tetracarboxylic dianhydride residue and a diamine residue. The tetracarboxylic dianhydride residue includes a 3,3′,4,4′-biphenyltetracarboxylic dianhydride residue and a spiro[11H-difuro[3,4-b:3′,4′-i]xanthene-11,9′-[9H]fluorene]-1,3,7,9-tetrone residue. That is, the polyamic acid (1) includes a 3,3′,4,4′-biphenyltetracarboxylic dianhydride residue and a spiro[11H-difuro[3,4-b:3′,4′-i]xanthene-11,9′-[9H]fluorene]-1,3,7,9-tetrone residue, as the tetracarboxylic dianhydride residue. The diamine residue includes a p-phenylenediamine residue. That is, the polyamic acid (1) includes a p-phenylenediamine residue as the diamine residue. At least one of the tetracarboxylic dianhydride residue or the diamine residue further includes a residue having an ester bond. At least one of the tetracarboxylic dianhydride residue or the diamine residue further includes a residue having a diphenyl ether structure.

Hereinafter, 3,3′,4,4′-biphenyltetracarboxylic dianhydride may be described as “BPDA.” Spiro[11H-difuro[3,4-b:3′,4′-i]xanthene-11,9′-[9H]fluorene]-1,3,7,9-tetrone may be described as “SFDA.” p-Phenylenediamine may be described as “PDA”. The residue having an ester bond may be described as “ester bond-containing residue.” The residue having a diphenyl ether structure may be described as “diphenyl ether structure-containing residue”. The SFDA residue is a tetravalent organic group represented by Chemical Formula (16) described below.

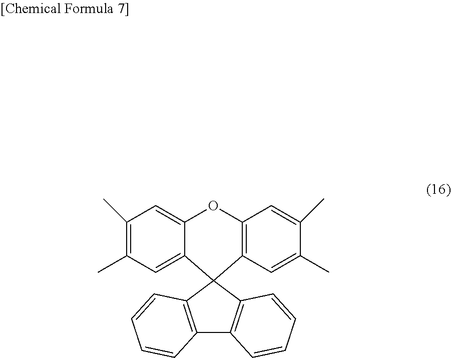

The polyamic acid composition according to one or more embodiments is excellent in storage stability. A polyimide produced using the polyamic acid composition according to one or more embodiments is excellent in heat resistance and adhesion to an inorganic oxide film. The reason for these is presumed as follows.

The polyamic acid (1) contained in the polyamic acid composition according to one or more embodiments has a BPDA residue, an SFDA residue, and a PDA residue. Each of the BPDA residue, the SFDA residue, and the PDA residue has a rigid structure. Therefore, a polyimide produced using the polyamic acid composition according to one or more embodiments is excellent in heat resistance.

In a high-temperature process (for example, annealing treatment of a TFT), imidization of an unreacted site in a polyimide film generally proceeds, and generation of a low molecular weight component from the polyimide film may cause outgassing. Outgassing causes deterioration of the adhesion between the polyimide film and the inorganic oxide film. In contrast, the polyamic acid (1) contained in the polyamic acid composition according to one or more embodiments includes an SFDA residue having a bulky structure derived from a fluorene structure, and thus enables formation of a polyimide film excellent in a gas release property. The polyamic acid (1) contained in the polyamic acid composition according to one or more embodiments has an ester bond-containing residue. The ester bond-containing residue tends to easily interact with the inorganic oxide in the inorganic oxide film. Thus, a polyimide produced using the polyamic acid composition according to one or more embodiments is excellent in adhesion to an inorganic oxide film.

The polyamic acid (1) contained in the polyamic acid composition according to one or more embodiments has a diphenyl ether structure-containing residue. The diphenyl ether structure-containing residue tends to enhance the solubility in the organic solvent. Therefore, the polyamic acid composition according to one or more embodiments is excellent in storage stability.

In one or more embodiments, only one of the tetracarboxylic dianhydride residue or the diamine residue may have an ester bond-containing residue, or both the tetracarboxylic dianhydride residue and the diamine residue may have an ester bond-containing residue.

In a case where the tetracarboxylic dianhydride residue has an ester bond-containing residue, the ester bond-containing residue may be one or more selected from the group consisting of tetravalent organic groups represented by General Formula (1) described below and a tetravalent organic group represented by Chemical Formula (2) described below.

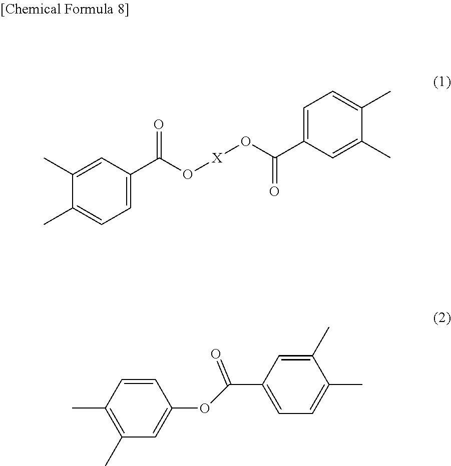

In General Formula (1), X represents a divalent organic group represented by General Formula (3) described below, a divalent organic group represented by General Formula (4) described below, a divalent organic group represented by General Formula (5) described below, a divalent organic group represented by Chemical Formula (6) described below, or a divalent organic group represented by Chemical Formula (7) described below.

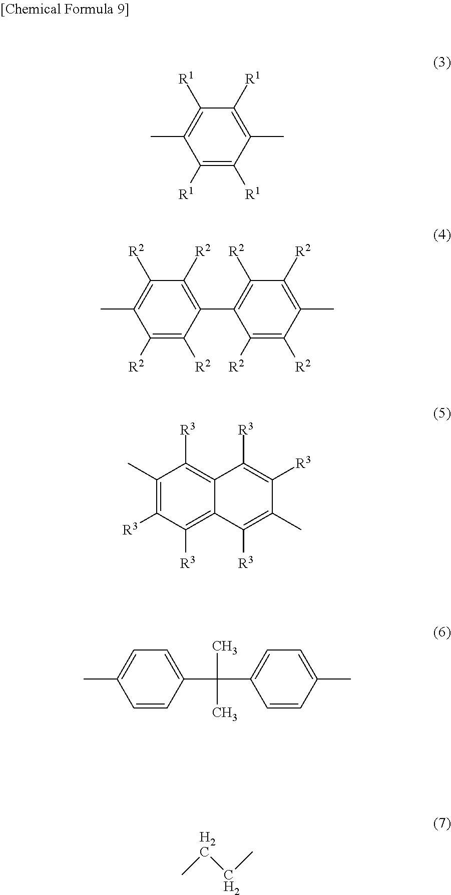

In General Formulas (3), (4), and (5), R¹, R², and R³ each independently represent a hydrogen atom, a methyl group, an ethyl group, or a trifluoromethyl group, a plurality of R¹s are optionally equal to or different from each other, a plurality of R²s are optionally equal to or different from each other, and a plurality of R³s are optionally equal to or different from each other.

In order to obtain a polyimide more excellent in adhesion to an inorganic oxide film, the tetravalent organic group represented by General Formula (1) may be a residue derived from p-phenylenebis(trimellitic acid monoester anhydride). Hereinafter, p-phenylenebis(trimellitic acid monoester anhydride) may be described as “TMHQ.” The TMHQ residue has a structure in which X in General Formula (1) represents a divalent organic group represented by General Formula (3) and all of R¹s in General Formula (3) represent a hydrogen atom.

The tetravalent organic group represented by Chemical Formula (2) is a residue derived from (1,3-dioxoisobenzofuran-5-yl)1,3-dioxoisobenzofuran-5-carboxylate (hereinafter, sometimes described as “8CI”).

In order to obtain a polyimide more excellent in adhesion to an inorganic oxide film, the ester bond-containing residue included in the tetracarboxylic dianhydride residue may be the tetravalent organic group represented by General Formula (1), or a TMHQ residue.

In a case where the diamine residue has an ester bond-containing residue, the ester bond-containing residue may be one or more selected from the group consisting of a divalent organic group represented by Chemical Formula (8) described below, divalent organic groups represented by General Formula (9) described below, and divalent organic groups represented by General Formula (10) described below.

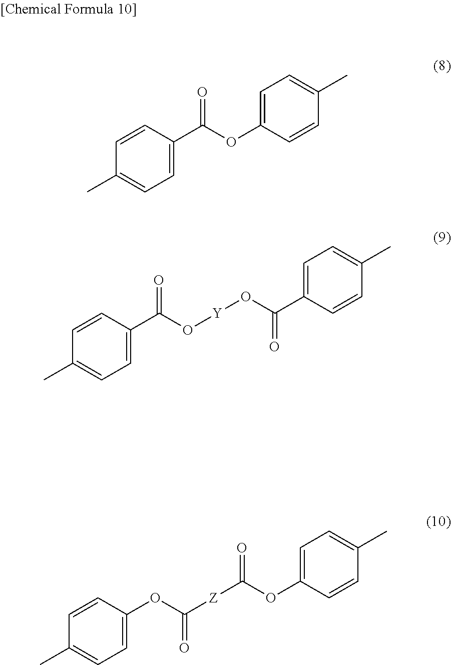

In General Formulas (9) and (10), Y and Z each independently represent a divalent organic group represented by General Formula (11) described below, a divalent organic group represented by General Formula (12) described below, or a divalent organic group represented by General Formula (13) described below.

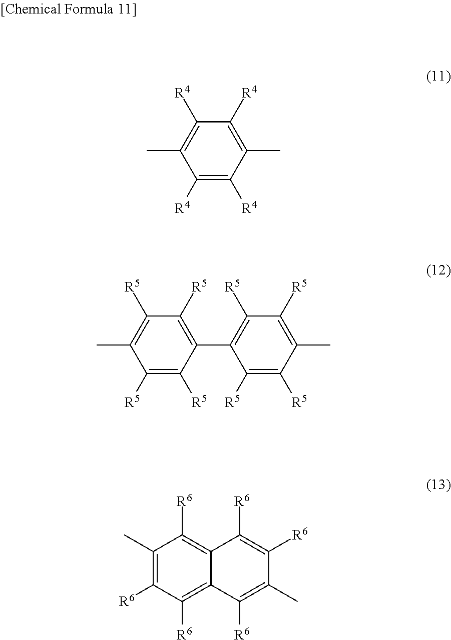

In General Formulas (11), (12), and (13), R⁴, R⁵, and R⁶ each independently represent a hydrogen atom, a methyl group, an ethyl group, or a trifluoromethyl group, a plurality of R⁴s are optionally equal to or different from each other, a plurality of R⁵s are optionally equal to or different from each other, and a plurality of R⁶s are optionally equal to or different from each other.

In order to obtain a polyimide more excellent in adhesion to an inorganic oxide film while achieving excellent heat resistance, the ester bond-containing residue included in the diamine residue may be the divalent organic group represented by Chemical Formula (8). The divalent organic group represented by Chemical Formula (8) is a residue derived from 4-aminophenyl-4-aminobenzoate (hereinafter, sometimes described as “4-BAAB”).

In order to obtain a polyimide more excellent in heat resistance and adhesion to an inorganic oxide film, the ester bond-containing residue may be one or more selected from the group consisting of a TMHQ residue, an 8CI residue, and a 4-BAAB residue, or may be a 4-BAAB residue.

In one or more embodiments, only one of the tetracarboxylic dianhydride residue or the diamine residue may have a diphenyl ether structure-containing residue, or both the tetracarboxylic dianhydride residue and the diamine residue may have a diphenyl ether structure-containing residue.

In a case where the tetracarboxylic dianhydride residue has a diphenyl ether structure-containing residue, examples of the diphenyl ether structure-containing residue include a 4,4′-oxydiphthalic anhydride residue, a 3,4′-oxydiphthalic anhydride residue, a 4,4′-(4,4′-isopropylidenediphenoxy)bisphthalic anhydride residue, and a hydroquinone diphthalic anhydride residue. Among them, a 4,4′-oxydiphthalic anhydride residue is preferable in order to obtain a polyamic acid composition more excellent in storage stability. Hereinafter, 4,4′-oxydiphthalic anhydride may be described as “ODPA”.

In a case where the diamine residue has a diphenyl ether structure-containing residue, examples of the diphenyl ether structure-containing residue include a 4,4′-oxydianiline residue, a 3,4′-oxydianiline residue, a 2,2-bis[4-(4-aminophenoxy)phenyl]propane residue, a 1,4-bis(4-aminophenoxy)benzene residue, a 1,3-bis(4-aminophenoxy)benzene residue, a 1,3-bis(3-aminophenoxy)benzene residue, a 4,4′-bis(4-aminophenoxy)biphenyl residue, a bis[4-(4-aminophenoxy)phenyl]sulfone residue, and a bis[4-(3-aminophenoxy)phenyl]sulfone residue. Among them, a 4,4′-oxydianiline residue is preferable in order to obtain a polyamic acid composition more excellent in storage stability. Hereinafter, 4,4′-oxydianiline may be described as “ODA”.

In order to obtain a polyimide more excellent in heat resistance while further enhancing the storage stability of the polyamic acid composition, the diphenyl ether structure-containing residue may be one or more selected from the group consisting of an ODPA residue and an ODA residue.

As the acid dianhydride for synthesis of the polyamic acid (1), an acid dianhydride other than the above-described acid dianhydrides (another acid dianhydride) may be used. Examples of another acid dianhydride include pyromellitic dianhydride, 2,3,6,7-naphthalenetetracarboxylic dianhydride, 1,2,5,6-naphthalenetetracarboxylic dianhydride, 2,2′,3,3′-biphenyltetracarboxylic dianhydride, 3,3′,4,4′-benzophenonetetracarboxylic dianhydride, 9,9-bis(3,4-dicarboxyphenyl)fluorene dianhydride, dicyclohexyl-3,3′,4,4′-tetracarboxylic dianhydride, 1,2,4,5-cyclohexanetetracarboxylic dianhydride, 1,2,3,4-cyclobutanetetracarboxylic dianhydride, and derivatives thereof, and these may be used singly or in combination of two or more kinds thereof.

As the diamine for synthesis of the polyamic acid (1), a diamine other than the above-described diamines (another diamine) may be used. Examples of another diamine include 2,2′-bis(trifluoromethyl)benzidine, 1,4-diaminocyclohexane, m-phenylenediamine, 9,9-bis(4-aminophenyl)fluorene, 4,4′-diaminobenzanilide, N,N-bis(4-aminophenyl)terephthalamide, 4,4′-diaminodiphenylsulfone, m-tolidine, o-tolidine, 3,5-diaminobenzoic acid, 4,4′-diamino-3,3′-dihydroxybiphenyl, 4,4′-methylenebis(cyclohexanamine), 1,3-bis(3-aminopropyl)tetramethyldisiloxane, and derivatives thereof, and these may be used singly or in combination of two or more kinds thereof.

In order to obtain a polyimide more excellent in heat resistance, the content of the BPDA residue with respect to the total amount (100 mol %) of the acid dianhydride residue included in the polyamic acid (1) may be 50 mol % or more and 95 mol % or less, or 60 mol % or more and 93 mol % or less.

In order to suppress an increase in the CTE and reduce the internal stress at the time of forming a laminate, the content of the SFDA residue with respect to the total amount (100 mol %) of the acid dianhydride residue included in the polyamic acid (1) may be 10 mol % or less. In order to obtain a polyimide more excellent in heat resistance and adhesion to an inorganic oxide film, the content of the SFDA residue may be 1 mol % or more and 10 mol % or less, or 2 mol % or more and 10 mol % or less with respect to the total amount (100 mol %) of the acid dianhydride residue included in the polyamic acid (1).

In order to obtain a polyimide more excellent in heat resistance, the content of the PDA residue with respect to the total amount (100 mol %) of the diamine residue included in the polyamic acid (1) may be 70 mol % or more and 98 mol % or less, or 80 mol % or more and 97 mol % or less.

In order to obtain a polyimide more excellent in adhesion to an inorganic oxide film, the content of the ester bond-containing residue may be 1 mol % or more and 30 mol % or less, or 2 mol % or more and 20 mol % or less with respect to the total (200 mol %) of the total amounts of the acid dianhydride residue and the diamine residue included in the polyamic acid (1).

In a case where the polyamic acid (1) has an ester bond-containing residue as the acid dianhydride residue, in order to obtain a polyimide more excellent in adhesion to an inorganic oxide film, the content of the ester bond-containing residue as the acid dianhydride residue may be 1 mol % or more and 30 mol % or less, or 2 mol % or more and 20 mol % or less with respect to the total amount (100 mol %) of the acid dianhydride residue included in the polyamic acid (1).

In a case where the polyamic acid (1) has an ester bond-containing residue as the diamine residue, in order to obtain a polyimide more excellent in adhesion to an inorganic oxide film, the content of the ester bond-containing residue as the diamine residue may be 3 mol % or more and 30 mol % or less, or 5 mol % or more and 20 mol % or less with respect to the total amount (100 mol %) of the diamine residue included in the polyamic acid (1).

In order to obtain a polyamic acid composition more excellent in storage stability, the content of the diphenyl ether structure-containing residue may be 1 mol % or more and 40 mol % or less, or 3 mol % or more and 30 mol % or less with respect to the total (200 mol %) of the total amounts of the acid dianhydride residue and the diamine residue included in the polyamic acid (1).

In a case where the polyamic acid (1) has a diphenyl ether structure-containing residue as the acid dianhydride residue, in order to obtain a polyamic acid composition more excellent in storage stability, the content of the diphenyl ether structure-containing residue as the acid dianhydride residue may be 1 mol % or more and 40 mol % or less, or 3 mol % or more and 30 mol % or less with respect to the total amount (100 mol %) of the acid dianhydride residue included in the polyamic acid (1).

In a case where the polyamic acid (1) has a diphenyl ether structure-containing residue as the diamine residue, in order to obtain a polyamic acid composition more excellent in storage stability, the content of the diphenyl ether structure-containing residue as the diamine residue may be 3 mol % or more and 20 mol % or less, or 5 mol % or more and 10 mol % or less with respect to the total amount (100 mol %) of the diamine residue included in the polyamic acid (1).

In order to obtain a polyamic acid composition that enables production of a polyimide more excellent in heat resistance and adhesion to an inorganic oxide film while achieving more excellent storage stability, the total content of the BPDA residue, the SFDA residue, the PDA residue, the ester bond-containing residue, and the diphenyl ether structure-containing residue may be 125 mol % or more and 200 mol % or less, 150 mol % or more and 200 mol % or less, 180 mol % or more and 200 mol % or less, or 190 mol % or more and 200 mol % or less, and may be 200 mol %, with respect to the total (200 mol %) of the total amounts of the acid dianhydride residue and the diamine residue included in the polyamic acid (1).

In order to obtain a polyamic acid composition that enables production of a polyimide more excellent in heat resistance and adhesion to an inorganic oxide film while achieving more excellent storage stability, the polyamic acid composition according to one or more embodiments may satisfy the following condition 1, the following condition 2, the following condition 3, or the following condition 4.

Condition 1: The total content of the BPDA residue, the SFDA residue, the PDA residue, the ester bond-containing residue, and the diphenyl ether structure-containing residue is 180 mol % or more and 200 mol % or less with respect to the total (200 mol %) of the total amounts of the acid dianhydride residue and the diamine residue included in the polyamic acid (1).

Condition 2: The condition 1 is satisfied, and the content of the SFDA residue is 1 mol % or more and 10 mol % or less with respect to the total amount (100 mol %) of the acid dianhydride residue included in the polyamic acid (1).

Condition 3: The condition 2 is satisfied, and the content of the ester bond-containing residue is 1 mol % or more and 30 mol % or less with respect to the total (200 mol %) of the total amounts of the acid dianhydride residue and the diamine residue included in the polyamic acid (1).

Condition 4: The condition 3 is satisfied, and the content of the diphenyl ether structure-containing residue is 1 mol % or more and 40 mol % or less with respect to the total (200 mol %) of the total amounts of the acid dianhydride residue and the diamine residue included in the polyamic acid (1).

The polyamic acid (1) can be synthesized with a known general method, and can be obtained, for example, by reacting a diamine with a tetracarboxylic dianhydride in an organic solvent. An example of a specific synthesis method of the polyamic acid (1) will be described. First, in an atmosphere of an inert gas such as argon or nitrogen, a diamine is dissolved or dispersed in a slurry form in an organic solvent to prepare a diamine solution. Then, a tetracarboxylic dianhydride in a state of being dissolved or dispersed in a slurry form in an organic solvent, or a tetracarboxylic dianhydride in a solid state is added to the diamine solution.

In the case of synthesizing a polyamic acid (1) using a diamine and a tetracarboxylic dianhydride, a desired polyamic acid (1) (polymer of a diamine and a tetracarboxylic dianhydride) can be obtained by adjusting the substance amount of the diamine (substance amount of each diamine in a case where a plurality of diamines are used) and the substance amount of the tetracarboxylic dianhydride (substance amount of each tetracarboxylic dianhydride in a case where a plurality of tetracarboxylic dianhydrides are used). The molar fraction of each residue in the polyamic acid (1) is equal to, for example, the molar fraction of each monomer (each of the diamines and the tetracarboxylic dianhydrides) used for synthesis of the polyamic acid (1). A polyamic acid (1) containing a plurality of tetracarboxylic dianhydride residues and a plurality of diamine residues can also be obtained by blending two polyamic acids. The temperature condition for the reaction of the diamine with the tetracarboxylic dianhydride, that is, the synthesis reaction of the polyamic acid (1) is not particularly limited, and is, for example, in the range of 20° C. or higher and 150° C. or lower. The reaction time for the synthesis reaction of the polyamic acid (1) is, for example, in the range of 10 minutes or more and 30 hours or less.

The organic solvent used for synthesis of the polyamic acid (1) may be a solvent capable of dissolving the tetracarboxylic dianhydride and the diamine to be used, or a solvent capable of dissolving the polyamic acid (1) to be generated. Examples of the organic solvent used for synthesis of the polyamic acid (1) include urea-based solvents such as tetramethylurea and N,N-dimethylethylurea; sulfoxide-based solvents such as dimethyl sulfoxide; sulfone-based solvents such as diphenyl sulfone and tetramethyl sulfone; amide-based solvents such as N,N-dimethylacetamide (DMAC), N,N-dimethylformamide (DMF), N,N-diethylacetamide (DEF), N-methyl-2-pyrrolidone (NMP), 3-methoxy-N,N-dimethylpropanamide (MPA), 3-butoxy-N,N-dimethylpropanamide (BPA), N,N-dimethylpropionamide (DMPA), and hexamethylphosphoric triamide; ester-based solvents such as y-butyrolactone; alkyl halide-based solvents such as chloroform and methylene chloride; aromatic hydrocarbon-based solvents such as benzene and toluene; phenol-based solvents such as phenol and cresol; ketone-based solvents such as cyclopentanone; and ether-based solvents such as tetrahydrofuran, 1,3-dioxolane, 1,4-dioxane, dimethyl ether, diethyl ether, diethylene glycol diethyl ether, diethylene glycol dimethyl ether, and p-cresol methyl ether. These solvents are normally used singly, and if necessary, may be appropriately used in combination of two or more kinds thereof.

In order to enhance the solubility and the reactivity of the polyamic acid (1), the organic solvent used in the synthesis reaction of the polyamic acid (1) may be one or more solvents selected from the group consisting of amide-based solvents, ketone-based solvents, ester-based solvents, and ether-based solvents, or an amide-based solvent. The synthesis reaction of the polyamic acid (1) may be performed under an atmosphere of an inert gas such as argon or nitrogen.

Examples of the organic solvent contained in the polyamic acid composition according to one or more embodiments include the organic solvents exemplified as the organic solvent usable in the synthesis reaction of the polyamic acid (1), and the organic solvent contained in the polyamic acid composition according to one or more embodiments may be one or more solvents selected from the group consisting of amide-based solvents, ketone-based solvents, ester-based solvents, and ether-based solvents, or an amide-based solvent.

In the case of using an amide-based solvent as the organic solvent contained in the polyamic acid composition according to one or more embodiments, examples of an organic solvent having little influence on the environment and the human body and having high safety include compounds represented by General Formula (14) described below.

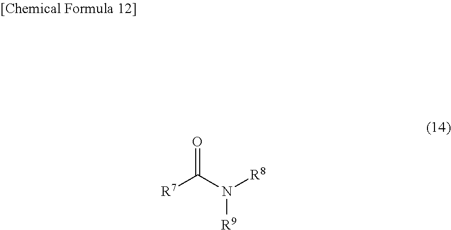

In General Formula (14), R⁷, R⁸, and R⁹ each independently represent a monovalent organic group having 1 or more carbon atoms or represent a hydrogen atom, and at least one of R⁷, R⁸, or R⁹ represents a monovalent organic group having 2 or more carbon atoms.

In order to enhance safety, only a compound represented by General Formula (14) may be used as the organic solvent contained in the polyamic acid composition according to one or more embodiments. Examples of the compound represented by General Formula (14) include MPA, BPA, DMPA, and DEF. In order to further enhance safety, the compound represented by General Formula (14) may be MPA.

In the case of obtaining the polyamic acid (1) with the above-described method, the reaction solution (solution after the reaction) itself may be used as the polyamic acid composition according to one or more embodiments. Alternatively, the solid polyamic acid (1) obtained by removing the solvent from the reaction solution may be dissolved in an organic solvent to prepare the polyamic acid composition according to one or more embodiments. The content of the polyamic acid (1) in the polyamic acid composition according to one or more embodiments is not particularly limited, and is, for example, 1 wt % or more and 80 wt % or less with respect to the total amount of the polyamic acid composition.

In order to obtain a polyamic acid composition more excellent in storage stability, the polyamic acid composition may have a viscosity change ratio within ±30%, or within ±20% when stored for 14 days in an environment at a temperature of 23° C. and a relative humidity of 55%. The method of measuring the viscosity change ratio is the same as or similar to the method in Examples described below.

The weight average molecular weight of the polyamic acid (1) may be in the range of 10,000 or more and 1,000,000 or less, in the range of 20,000 or more and 500,000 or less, or in the range of 30,000 or more and 200,000 or less although depending on the use of the polyamic acid (1). If the weight average molecular weight is 10,000 or more, the polyamic acid (1) or a polyimide obtained using the polyamic acid (1) is easily formed into a coating film or a polyimide film (film). Meanwhile, if the weight average molecular weight is 1,000,000 or less, the polyamic acid (1) exhibits sufficient solubility in a solvent, and therefore a coating film or a polyimide film having a smooth surface and a uniform thickness can be obtained using the polyamic acid composition. The weight average molecular weight used herein refers to a value in terms of polyethylene oxide measured using gel permeation chromatography (GPC).

Examples of a method of controlling the molecular weight of the polyamic acid (1)include a method in which an acid dianhydride or a diamine is excessively used, and a method in which a monofunctional acid anhydride or a monofunctional amine, such as phthalic anhydride or aniline, is reacted to quench the reaction. In order to obtain a polyimide more excellent in adhesion to an inorganic oxide film, a diamine may be excessively used for polymerization. In a case where an acid dianhydride or a diamine is excessively used for polymerization, a polyimide film having sufficient strength can be obtained as long as the molar ratio of the diamine to the acid dianhydride for preparation is in the range from 0.95 to 1.05. The above-described molar ratio of the diamine to the acid dianhydride for preparation is the ratio of the total substance amount of the diamine used for synthesis of the polyamic acid (1) to the total substance amount of the acid dianhydride used for synthesis of the polyamic acid (1) (total substance amount of diamine/total substance amount of acid dianhydride). It is also possible to use phthalic anhydride, maleic anhydride, aniline, or the like for end-capping to further reduce coloring of the polyimide obtained using the polyamic acid (1).

The polyimide according to one or more embodiments is an imidized product of the above-described polyamic acid (1). The polyimide according to one or more embodiments can be obtained with a known method, and the method of producing the polyimide is not particularly limited. Hereinafter, an example of the method will be described in which the polyamic acid (1) is imidized to obtain the polyimide according to one or more embodiments. The imidization is performed by subjecting the polyamic acid (1) to cyclodehydration. The cyclodehydration can be performed with an azeotropic method using an azeotropic solvent, a thermal method, or a chemical method. Imidization from the polyamic acid (1) to a polyimide can be performed at any percentage of 1% or more and 100% or less. That is, the polyamic acid (1) that is partially imidized may be synthesized. In particular in the case of imidization by heating, the ring closure reaction from the polyamic acid (1) to a polyimide and the hydrolysis of the polyamic acid (1) proceed at the same time, and the resulting polyimide may have a lower molecular weight than the polyamic acid (1). Therefore, the polyamic acid (1) in the polyamic acid composition may be partially imidized in advance before forming a polyimide film described below from the viewpoint of improving a mechanical property. In the present description, the partially imidized polyamic acid may also be described as “polyamic acid.”

Cyclodehydration of the polyamic acid (1) is to be performed by heating the polyamic acid (1). The method of heating the polyamic acid (1) is not particularly limited, and for example, a method may be used in which the polyamic acid composition according to one or more embodiments described above is applied onto a support such as a glass substrate, an inorganic oxide film (more specifically, an oxide silicon film or the like), a metal plate, or a polyethylene terephthalate film (PET film) and then the polyamic acid (1) is heat-treated at a temperature in the range of 40° C. or higher and 500° C. or lower. This method provides a laminate according to one or more embodiments including a support and a polyimide film (specifically, a polyimide film containing an imidized product of the polyamic acid (1)) disposed on the support. Alternatively, cyclodehydration of the polyamic acid (1) can be performed by directly putting the polyamic acid composition into a container subjected to a release treatment such as coating with a fluorine-based resin, and heating and drying the polyamic acid composition under reduced pressure. A polyimide can be obtained by cyclodehydration of the polyamic acid (1) with these methods. The heating time in each treatment described above depends on the amount of the polyamic acid composition subjected to cyclodehydration and the heating temperature, but the heating time may be in the range of 1 minute or more and 300 minutes or less after the treatment temperature reaches the maximum temperature. In order to shorten the heating time and develop a property, imidization may be performed by adding an imidization agent and/or a dehydration catalyst to the polyamic acid composition and, with the above method, heating the polyamic acid composition to which the imidization agent and/or the dehydration catalyst is added.

The imidization agent is not particularly limited, and a tertiary amine can be used. The tertiary amine may be a heterocyclic tertiary amine. Preferable specific examples of a heterocyclic tertiary amine include pyridine, picoline, quinoline, isoquinoline, and 1,2-dimethylimidazole. Preferable specific examples of the dehydration catalyst include acetic anhydride, propionic anhydride, n-butyric anhydride, benzoic anhydride, and trifluoroacetic anhydride.

The amount of the imidization agent added may be 0.5 times molar equivalent or more and 5.0 times molar equivalent or less, 0.7 times molar equivalent or more and 2.5 times molar equivalent or less, or 0.8 times molar equivalent or more and 2.0 times molar equivalent or less with respect to the amide group of the polyamic acid (1). The amount of the dehydration catalyst added may be 0.5 times molar equivalent or more and 10.0 times molar equivalent or less, 0.7 times molar equivalent or more and 5.0 times molar equivalent or less, or 0.8 times molar equivalent or more and 3.0 times molar equivalent or less with respect to the amide group of the polyamic acid (1). In the present description, the term “amide group of the polyamic acid (1)” refers to an amide group generated by a polymerization reaction between a diamine and a tetracarboxylic dianhydride. When added to the polyamic acid composition, the imidization agent and/or the dehydration catalyst may be directly added without being dissolved in an organic solvent, or may be dissolved in an organic solvent and the resulting solution may be added. In the method of direct addition without dissolution in an organic solvent, the reaction may rapidly proceed before diffusion of the imidization agent and/or the dehydration catalyst, resulting in generation of a gel. Therefore, a solution obtained by dissolving the imidization agent and/or the dehydration catalyst in an organic solvent may be added to the polyamic acid composition.

The polyimide film (specifically, polyimide film containing an imidized product of the polyamic acid (1)) according to one or more embodiments is colorless and transparent and has a low yellowness index and a glass transition temperature (heat resistance) to be resistant to a step of preparing a TFT, and therefore is suitable for a transparent substrate material of a flexible display. The content of the polyimide (specifically, imidized product of the polyamic acid (1)) in the polyimide film according to one or more embodiments may be, for example, 70 wt % or more, 80 wt % or more, or 90 wt % or more, and may be 100 wt % with respect to the total amount of the polyimide film. Examples of the component other than the polyimide in the polyimide film include additives (more specifically, fine particles and the like) described below.

An electronic device (for example, flexible device or the like) according to one or more embodiments includes the polyimide film according to one or more embodiments and an electronic element directly or indirectly disposed on the polyimide film. In the case of producing the electronic device according to one or more embodiments for a flexible display, first, a polyimide film is formed on an inorganic substrate such as glass as a support. Then, an electronic element such as a TFT is disposed (formed) on the polyimide film to form an electronic device on the support. The step of forming a TFT is generally performed in a wide temperature range of 150° C. or higher and 650° C. or lower, and in order to actually achieve desired performance, an oxide semiconductor layer or an a-Si layer is formed at 300° C. or higher, and in some cases, a-Si or the like is further crystallized with a laser or the like.

At this time, if the polyimide film has a low thermal decomposition temperature, outgassing occurs during formation of an electronic element, and a sublimate may adhere to the inside of the oven to cause contamination in the furnace, or an inorganic film (a barrier film or the like described below) formed on the polyimide film or the electronic element may be peeled off Therefore, the polyimide may have a 1% weight loss temperature of 450° C. or higher, or 500° C. or higher. The upper limit of the 1% weight loss temperature of the polyimide may be as high as possible, and is, for example, 580° C. The 1% weight loss temperature can be adjusted, for example, by changing the content of a residue having a rigid structure (more specifically, a BPDA residue, a PDA residue, or the like). More specifically, before forming a TFT, an inorganic film such as a silicon oxide film (SiOx film) or a silicon nitride film (SiNx film) is formed as a barrier film on the polyimide film. At this time, if the polyimide has low heat resistance, or progress of imidization is incomplete, or the amount of the residual solvent is large, a volatile component such as a decomposition gas of the polyimide may cause peeling of the polyimide and the inorganic film in a high-temperature process after layering of the inorganic film. Therefore, it is desirable that the polyimide has a 1% weight loss temperature of 450° C. or higher and that the polyimide isothermally held at a temperature in the range of 400° C. or higher and 450° C. or lower has a weight loss ratio of 1% or less.

If the polyimide has a glass transition temperature (Tg) significantly lower than the process temperature, positional deviation or the like may occur during formation of an electronic element. Therefore, the polyimide may have a Tg of 300° C. or higher, 350° C. or higher, or 400° C. or higher. The upper limit of the Tg of the polyimide may be as high as possible, and is, for example, 450° C. Furthermore, an internal stress is generated between the glass substrate and the polyimide film because a glass substrate generally has a smaller linear thermal expansion coefficient than a resin. If the internal stress is high in the laminate including the glass substrate used as a support, the electronic element, and the polyimide film, after the laminate including the polyimide film expands in the high-temperature TFT forming step, the laminate contracts when cooled to normal temperature to cause problems such as warpage and breakage of the glass substrate and peeling of the polyimide film from the glass substrate. Therefore, the internal stress generated in the laminate including the polyimide film and the glass substrate may be 30 MPa or less, 25 MPa or less, or 20 MPa or less.

The polyimide according to one or more embodiments can be suitably used as a material of a display substrate such as a TFT substrate or a touch panel substrate. In the above-described use of the polyimide, a method is often adopted in which an electronic device (specifically, electronic device in which an electronic element is formed on a polyimide film) is formed on a support as described above, and then the polyimide film is peeled from the support. As a material of the support, alkali-free glass is suitably used. After forming an inorganic oxide film such as a SiOx film on the support, a polyimide film may be formed on the inorganic oxide film. Hereinafter, an example of a method of producing a laminate including a polyimide film and a support will be described in detail.

First, the polyamic acid composition according to one or more embodiments is applied onto a support to form a coating film-containing laminate that includes a coating film containing the polyamic acid (1) and includes the support. Next, the coating film-containing laminate is heated under a condition of, for example, a temperature of 40° C. or higher and 200° C. or lower. The heating time at this time is, for example, 3 minutes or more and 120 minutes or less. A multi-stage heating step may be provided such that the coating film-containing laminate is heated at a temperature of 50° C. for 30 minutes and then heated at a temperature of 100° C. for 30 minutes. Next, in order to advance imidization of the polyamic acid (1) in the coating film, the coating film-containing laminate is heated under a condition of, for example, a maximum temperature of 200° C. or higher and 500° C. or lower. The heating time (heating time at the maximum temperature) at this time is, for example, 1 minute or more and 300 minutes or less. At this time, the temperature may be raised gradually from a low temperature to the maximum temperature. The temperature rise rate may be 2° C./min or more and 10° C./min or less, or 4° C./min or more and 10° C./min or less. The maximum temperature may be in the range of 250° C. or higher and 450° C. or lower. If the maximum temperature is 250° C. or higher, imidization sufficiently proceeds, and if the maximum temperature is 450° C. or lower, thermal deterioration and coloring of the polyimide can be suppressed. The temperature may be held at any temperature for any period of time until reaching the maximum temperature. The imidization reaction can be performed under air, under reduced pressure, or in an inert gas such as nitrogen, and in order to develop higher transparency, the imidization reaction may be performed under reduced pressure or in an inert gas such as nitrogen. As a heater, a known device such as a hot-air oven, an infrared oven, a vacuum oven, an inert oven, or a hot plate can be used. Through these steps, the polyamic acid (1) in the coating film is imidized, and a laminate (that is, the laminate according to one or more embodiments) can be obtained that includes the support and the polyimide film (film containing an imidized product of the polyamic acid (1)). In order to shorten the heating time and develop a property, imidization may be performed by adding an imidization agent or a dehydration catalyst to the polyamic acid composition and heating the resulting solution with the above method.

As a method of peeling the polyimide film from the obtained laminate including the support and the polyimide film, a known method can be used. For example, the polyimide film may be peeled manually, or may be peeled using a machine such as a drive roll or a robot. Furthermore, a method can be adopted in which a peeling layer is provided between a support and a polyimide film, and a method can be adopted in which a silicon oxide film is formed on a substrate having a large number of grooves, a polyimide film is formed using the silicon oxide film as a base layer, and an etching solution of silicon oxide is infiltrated between the substrate and the silicon oxide film to peel the polyimide film. In addition, a method can be adopted in which the polyimide film is separated by irradiation with laser light.

If floating occurs at the interface between the polyimide film and the support (for example, a glass substrate), the polyimide film may be peeled off during formation of an electronic element, or, after formation of an electronic element, the yield at the time of peeling off the polyimide film may be reduced. The term “floating” refers to a state in which adhesion failure due to outgassing caused during imidization or a remaining solvent occurs between the polyimide film and another material layer (more specifically, a glass substrate, a barrier film, an inorganic oxide film, or the like). Specific examples of the “floating” include a state in which the polyimide film is moved up from a glass substrate, a state in which a part of the polyimide film is broken to cause delamination between the polyimide film and another material layer, and a state in which an inorganic oxide film is moved up from the polyimide film. According to the polyamic acid composition according to one or more embodiments, a polyimide film excellent in a gas release property can be formed as described above, and thus occurrence of floating can be suppressed.

The transparency of the polyimide film can be evaluated with the total light transmittance (TT) in accordance with JIS K 7361-1: 1997 and the haze in accordance with JIS K 7136-2000. In a use of the polyimide film in which high transparency is required, the polyimide film may have a total light transmittance of 75% or more, or 80% or more. In a use of the polyimide film in which high transparency is required, the polyimide film may have a haze of 1.5% or less, 1.2% or less, or less than 1.0%, and may be 0%. In a use in which high transparency is required, the polyimide film is required to have high transmittance in the entire wavelength region, but the polyimide film tends to absorb light on the short wavelength side, and the film itself is often colored yellow. For a use of the polyimide film in which high transparency is required, coloring of the polyimide film may be reduced. Specifically, for a use of the polyimide film in which high transparency is required, the polyimide film may have a yellowness index (YI) of 20 or less, 18 or less, 15 or less, 12 or less, or 8 or less, and may be 0. The YI can be measured in accordance with JIS K 7373-2006. The YI can be adjusted, for example, by changing the content of the SFDA residue in the polyamic acid (1). As described above, the polyimide film in which coloring is reduced and transparency is imparted is suitable for a transparent substrate for use as a substitute for glass, or a substrate having a back surface on which a sensor or a camera module is provided.

The light extraction systems of flexible displays are classified into two types: a top emission system that extracts light from the front surface side of a TFT; and a bottom emission system that extracts light from the back surface side of a TFT. The top emission system is characterized in that light is not blocked by the TFT and thus the aperture ratio can be easily increased to obtain high definition image quality, and the bottom emission system is characterized in that alignment between the TFT and the pixel electrode is easy and thus the production is facilitated. If the TFT is transparent, the aperture ratio can be improved even in the bottom emission system, and therefore a large display tends to adopt a bottom emission system, which is easy to produce. The polyimide film according to one or more embodiments has a low YI and excellent heat resistance, and therefore can be applied to both of the light extraction systems described above.

In a batch-type device preparation process in which the polyamic acid composition is applied onto a support and imidized by heating, an electronic element or the like is formed, and then the polyimide film is peeled off, if the adhesion between the support and the polyimide film is low, the polyimide film may be peeled from the support in a step of forming an electronic element to adversely affect the formation of an electronic element. A laminate in which the polyimide film is provided on a support with an inorganic oxide film (for example, a SiOx film or the like) interposed therebetween may be excellent in adhesion between the inorganic oxide film and the polyimide film. The term “adhesion” as used herein means adhesive strength. In the case of producing an electronic device using the laminate in which the polyimide film is provided on a support with an inorganic oxide film interposed therebetween, the peel strength between the polyimide film and the inorganic oxide film may be 0.05 N/cm or more, 0.10 N/cm or more, or 0.10 N/cm or more and 1.00 N/cm or less from the viewpoint of improving productivity. The method of measuring the peel strength is the same as or similar to the method in Examples described below.

In a production process as described above, when the polyimide film is peeled from the laminate including the support and the polyimide film, the polyimide film is often peeled from the support by laser irradiation. In this case, the polyimide film needs to absorb the laser light, and therefore the polyimide film is required to have a cut-off wavelength longer than the wavelength of the laser light used for peeling. For laser peeling, a XeCl excimer laser with a wavelength of 308 nm is often used, and therefore the polyimide film may have a cut-off wavelength of 312 nm or more, or 330 nm or more. Meanwhile, the polyimide film having a long cut-off wavelength tends to be colored in yellow, and therefore the polyimide film may have a cut-off wavelength of 420 nm or less. From the viewpoint of achieving both the transparency (low yellowness) and the processability of laser peeling, the polyimide film may have a cut-off wavelength of 320 nm or more and 410 nm or less, or 330 nm or more and 400 nm or less. The cut-off wavelength in the present description means the wavelength at which the transmittance becomes 0.1% or less as measured by an ultraviolet-visible spectrophotometer.

The polyamic acid composition and the polyimide according to one or more embodiments may be used as they are in coating or a molding process for preparation of a product or a member, and can also be used as a material for a further treatment such as coating on a molded product molded into a film shape. For use in coating or a molding process, a composition containing the polyamic acid (1) or a polyimide may be prepared by dissolving or dispersing the polyamic acid composition or the polyimide in an organic solvent as necessary, and further blending a photocurable component, a thermosetting component, a non-polymerizable binder resin, and another component as necessary.

In order to impart a processing property and various functionalities to the polyamic acid composition and the polyimide according to one or more embodiments, various organic or inorganic low molecular weight compounds or polymer compounds may be blended as additives in the polyamic acid composition. As the additive, for example, a dye, a surfactant, a leveling agent, a plasticizer, silicone, fine particles, a sensitizer, or the like can be used. The fine particles include organic fine particles including polystyrene and polytetrafluoroethylene, and inorganic fine particles including colloidal silica, carbon, and layered silicate, and may have a porous structure or a hollow structure. The function and the form of the fine particles are not particularly limited, and may be, for example, a pigment, a filler, or fibrous particles.

As the additive for imparting functionalities described above, an imidazole can also be added to the polyamic acid composition according to one or more embodiments. In the present description, an imidazole refers to a compound having a 1,3-diazole ring (1,3-diazole ring structure). The imidazole is not particularly limited, and examples of the imidazole include 1H-imidazole, 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, and 1-benzyl-2-phenylimidazole. Among them, 1,2-dimethylimidazole, 1-benzyl-2-methylimidazole, 1-benzyl-2-phenylimidazole, and 2-phenylimidazole are preferable, and 1,2-dimethylimidazole, 1-benzyl-2-methylimidazole, and 2-phenylimidazole are more preferable.

The content of the imidazole may be 0.005 mol or more and 0.1 mol or less, 0.01 mol or more and 0.08 mol or less, or 0.015 mol or more and 0.050 mol or less with respect to 1 mol of the amide group of the polyamic acid (1). Setting the content of the imidazole to 0.005 mol or more can improve the film strength and the transparency of the polyimide, and setting the content of the imidazole to 0.1 mol or less can improve the Tg and the heat resistance while maintaining the storage stability of the polyamic acid (1).

The method of mixing the polyamic acid (1) and the imidazole is not particularly limited. From the viewpoint of ease of controlling the molecular weight of the polyamic acid (1), the imidazole may be added to the polyamic acid (1) after polymerization. At this time, the imidazole may be added to the polyamic acid (1) as it is, or a solution obtained by dissolving the imidazole in a solvent in advance may be added to the polyamic acid (1), and thus the addition method is not particularly limited. The imidazole may be added to a solution containing the polyamic acid (1) after polymerization (solution after the reaction) to prepare the polyamic acid composition according to one or more embodiments.

On a surface of the polyimide film according to one or more embodiments, various inorganic thin films may be formed such as a metal oxide thin film and a transparent electrode. The methods of forming these inorganic thin films are not particularly limited, and examples thereof include PVD methods such as a sputtering method, a vacuum vapor deposition method, and an ion plating method, and CVD methods.

In the polyimide film according to one or more embodiments, the internal stress generated at the time of forming a laminate with a glass substrate is so small that the adhesion to an inorganic material during a high-temperature process can be ensured in addition to the heat resistance, the low thermal expansion, and the transparency, and therefore the polyimide film may be used in fields and products where these properties are effective. For example, the polyimide film according to one or more embodiments may be used in an image display device such as a liquid crystal display device, an organic EL, or an electronic paper, a printed matter, a color filter, a flexible display, an optical film, a 3D display, a touch panel, a transparent conductive film substrate, a solar cell, or the like, and may be used as an alternative material for a portion where glass is currently used. In these uses, the polyimide film has a thickness of, for example, 1 μm or more and 200 μm or less, or 3 m or more and 100 m or less. The thickness of the polyimide film can be measured by using a laser hologage.

Furthermore, the polyamic acid composition according to one or more embodiments can be suitably used in a batch-type device preparation process in which the polyamic acid composition is applied onto a support and imidized by heating, an electronic element or the like is formed, and then the polyimide film is peeled off. Therefore, one or more embodiments also includes a method of producing a polyimide film, in which a laminate is obtained by the above-described method of producing a laminate according to one or more embodiments and then the polyimide film is obtained by peeling the polyimide film from the support. Furthermore, one or more embodiments also includes a method of producing an electronic device, in which a laminate is obtained by the above-described method of producing a laminate according to one or more embodiments and then an electronic element is formed on the formed polyimide film.

### EXAMPLES

Examples of one or more embodiments of the present invention will be described below, but the scope of the present invention is not limited to the following examples.

### <Methods of Measuring and Evaluating Physical Properties>

First, methods of measuring and evaluating physical properties of a polyimide (polyimide film) will be described.

### [Internal Stress]

Each polyamic acid composition prepared in Examples and Comparative Examples described below was applied with a spin coater onto a glass substrate manufactured by Corning Incorporated (trade name: Eagle XG, material: alkali-free glass, thickness: 0.7 mm, size: 100 mm×100 mm) measured in advance to determine the amount of warpage, and the resulting product was heated at 80° C. for 30 minutes in the air, and then heated at 350° C. for 60 minutes in a nitrogen atmosphere to obtain a laminate including a polyimide film having a thickness of 6 μm on the glass substrate. In order to eliminate the influence of water absorption of the polyimide film, the laminate was dried at 120° C. for 10 minutes, and then the amount of warpage of the laminate was measured in a nitrogen atmosphere at a temperature of 25° C. using a thin film stress measuring device (“FLX-2320-S” manufactured by KLA-Tencor Corporation). Then, from the amount of warpage of the glass substrate before formation of the polyimide film and the amount of warpage of the laminate, the internal stress generated between the glass substrate and the polyimide film was calculated with the Stoney equation.

### [1% Weight Loss Temperature (TD1)]

The polyimide film sampled from each laminate obtained in Examples and Comparative Examples described below (specifically, the polyimide film sampled so as to have a weight of 10 mg) was used as a sample for measurement, the temperature was raised from 25° C. to 650° C. under conditions of a nitrogen atmosphere and 20° C./min using a simultaneous thermogravimetry/differential thermal analyzer (“TG/DTA7200” manufactured by Hitachi High-Tech Science Corporation), the sample weight at a measurement temperature of 150° C. was used as a reference, and the measurement temperature when the sample weight was reduced by 1 wt % with respect to the reference was regarded as the 1% weight loss temperature (TD1). The polyimide film in a case where the TD1 was 450° C. or higher was evaluated as “excellent in heat resistance”. The polyimide film in a case where the TD1 was lower than 450° C. was evaluated as “not excellent in heat resistance”.

### [Linear Thermal Expansion Coefficient (CTE)]

For the polyimide film peeled from each laminate obtained in Examples and Comparative Examples described below, the CTE was measured under the condition of a load of 29.4 mN using a thermal analyzer (“TMA/SS7100” manufactured by Hitachi High-Tech Science Corporation). Specifically, the polyimide film (width: 3 mm, length: 10 mm) was heated in a nitrogen atmosphere from 10° C. to 350° C. under the condition of a temperature rise rate of 10° C./min, and then cooled at a temperature fall rate of 40° C./min, and at this time, the CTE was determined from the amount of strain in the range from 100° C. to 300° C. at the time of temperature fall.

### [Peel Strength]

First, a SiOx film (thickness: 1 μm) was layered on a glass substrate manufactured by Corning Incorporated (trade name: Eagle XG, material: alkali-free glass, thickness: 0.7 mm, size: 100 mm×100 mm) with a plasma CVD method. Next, each polyamic acid composition prepared in Examples and Comparative Examples described below was applied with a spin coater onto the SiOx film, and the resulting product was heated at 80° C. for 30 minutes in the air and then heated at 350° C. for 60 minutes in a nitrogen atmosphere to obtain a laminate in which the SiOx film and a polyimide film (thickness: 6 μm) were layered in this order on the glass substrate. In accordance with the standard of ASTM D1876-01, a cut having a width of 10 mm was made with a knife in the polyimide film of the obtained laminate, and the peel strength was determined to be the average peel strength obtained by peeling the polyimide film by 50 mm using a tensile tester (“Strograph VES 1D” manufactured by Toyo Seiki Seisaku-sho, Ltd.) in an environment at a temperature of 23° C. and a relative humidity of 55% under the conditions of a tensile speed of 50 mm/min and a peel angle of 90°. The polyimide film in a case where the peel strength was 0.10 N/cm or more was evaluated as “excellent in adhesion to an inorganic oxide film.” The polyimide film in a case where the peel strength was less than 0.10 N/cm was evaluated as “not excellent in adhesion to an inorganic oxide film.”

### [Storage Stability]

First, using a viscometer (“RE-215/U” manufactured by Toki Sangyo Co., Ltd.), the viscosity of each polyamic acid composition prepared in Examples and Comparative Examples described below was measured in an environment at a temperature of 23° C. in accordance with JIS K7117-2:1999. Hereinafter, the viscosity obtained here is described as “initial viscosity”. Next, each polyamic acid composition was put into a 50 mL screw bottle, the bottle was sealed and stored in an environment at a temperature of 23° C. and a relative humidity of 55% for 14 days, and then the viscosity of each polyamic acid composition after storage was measured with the same method as described above. Hereinafter, the viscosity obtained here is described as “viscosity after storage”. Then, the viscosity change ratio (unit: %) was calculated in accordance with the formula “viscosity change ratio=100×(viscosity after storage−initial viscosity)/initial viscosity”. The polyamic acid composition in a case where the viscosity change ratio was within ±20% was evaluated as A (excellent in storage stability). The polyamic acid composition in a case where the viscosity change ratio was out of the range of 20% was evaluated as B (not excellent in storage stability).

### <Preparation of Polyimide Film>

Hereinafter, the methods for preparing a polyimide film (laminate) in Examples and Comparative Examples will be described. In the following, compounds and reagents are represented by the following abbreviations. The polyamic acid compositions for use in preparation of the polyimide films were each prepared in a nitrogen atmosphere.
MPA: 3-Methoxy-N,N-dimethylpropanamide
BPDA: 3,3′,4,4′-Biphenyltetracarboxylic dianhydride
ODPA: 4,4′-Oxydiphthalic anhydride
SFDA: Spiro[11H-difuro[3,4-b:3′,4′-i]xanthene-11,9′-[9H]fluorene]-1,3,7,9-tetrone
TMHQ: p-Phenylenebis(trimellitic acid monoester acid anhydride)
8CI: (1,3-Dioxoisobenzofuran-5-yl) 1,3-dioxoisobenzofuran-5-carboxylate
BPAF: 9,9-Bis(3,4-dicarboxyphenyl)fluorene dianhydride
PDA: p-Phenylenediamine
4-BAAB: 4-Aminophenyl-4-aminobenzoate
ODA: 4,4′-Oxydianiline
TFMB: 2,2′-Bis(trifluoromethyl)benzidine

### Example 1

Into a 300 mL glass separable flask equipped with a stirrer including a stainless steel stirring rod and with a nitrogen inlet tube, 60.0 g of MPA was put as an organic solvent for polymerization. Then, 3.466 g of PDA and 0.804 g of 4-BAAB were put into the flask and dissolved while the flask contents were stirred. Then, 0.832 g of SFDA, 1.092 g of ODPA, and 8.806 g of BPDA were added to the flask contents, and then the flask contents were stirred for 4 hours in an atmosphere at a temperature of 40° C. Then, the flask contents were stirred for 24 hours in an atmosphere at a temperature of 23° C., then 235.0 g of MPA was put into the flask, and the flask contents were stirred for 1 hour in an atmosphere at a temperature of 23° C. to obtain a polyamic acid composition. The obtained polyamic acid composition was applied using a spin coater onto a glass substrate manufactured by Corning Incorporated (trade name: Eagle XG, material: alkali-free glass, thickness: 0.7 mm, size: 100 mm×100 mm), and the resulting product was heated at 80° C. for 30 minutes in the air, and then heated at 350° C. for 60 minutes in a nitrogen atmosphere to obtain a laminate including a polyimide film having a thickness of 6 μm on the glass substrate (laminate of Example 1). In Example 1, the ratio of the total substance amount of the used diamine to the total substance amount of the used acid dianhydride (total substance amount of diamine/total substance amount of acid dianhydride) was 101/100.

### Examples 2 to 15 and Comparative Examples 1 to 6

Laminates of Examples 2 to 15 and Comparative Examples 1 to 6 were obtained with the same method as in Example 1, except that the used acid dianhydride, the ratio of each acid dianhydride put into the flask, the used diamine, and the ratio of each diamine put into the flask were changed as shown in Table 1 and the thickness of the polyimide film was changed as shown in Table 2. The total substance amount of the acid dianhydride in each of Examples 2 to 15 and Comparative Examples 1 to 6 was the same as the total substance amount of the acid dianhydride in Example 1. The total substance amount of the diamine in each of Examples 2 to 15 and Comparative Examples 1 to 6 was the same as the total substance amount of the diamine in Example 1.

### <Results>

For Examples 1 to 15 and Comparative Examples 1 to 6, Table 1 shows the used acid dianhydride, the ratio of each acid dianhydride put into the flask, the used diamine, and the ratio of each diamine put into the flask. For Examples 1 to 15 and Comparative Examples 1 to 6, Table 2 shows the thickness of the polyimide film, the internal stress, the CTE, the TD1, the peel strength, and the evaluation results of the storage stability.

In Table 1, “-” means that the relevant component was not used. In Table 1, the numerical value in the column of “Acid dianhydride” is the content (unit: mol %) of each acid dianhydride to the total amount of acid dianhydrides used. In Table 1, the numerical value in the column of “Diamine” is the content (unit: mol %) of each diamine to the total amount of the used diamine. In each of Examples 1 to 15 and Comparative Examples 1 to 6, the molar fraction of each residue in the polyamic acid in the prepared polyamic acid composition was equal to the molar fraction of each monomer (each diamine and each tetracarboxylic dianhydride) used in synthesis of the polyamic acid. “-” in Table 2 means that the peel strength was not measured because floating occurred at the interface between the polyimide film and the SiOx film.

TABLE 1

| | Acid dianhydride [mol %] | | | | | | Diamine [mol %] | | | |
|---|---|---|---|---|---|---|---|---|---|---|
| | BPDA | ODPA | SFDA | TMHQ | 8CI | BPAF | PDA | 4-BAAB | ODA | TFMB |
| Example 1 | 85 | 10 | 5 | — | — | — | 90 | 10 | — | — |
| Example 2 | 85 | — | 5 | 10 | — | — | 90 | — | 10 | — |
| Example 3 | 75 | — | 5 | 20 | — | — | 90 | — | 10 | — |
| Example 4 | 85 | — | 5 | 10 | — | — | 95 | — | 5 | — |
| Example 5 | 90 | 5 | 5 | — | — | — | 90 | 10 | — | — |
| Example 6 | 80 | 15 | 5 | — | — | — | 95 | 5 | — | — |
| Example 7 | 86 | 10 | 4 | — | — | — | 90 | 10 | — | — |
| Example 8 | 75 | 20 | 5 | — | — | — | 90 | 10 | — | — |
| Example 9 | 92 | 3 | 5 | — | — | — | 90 | 10 | — | — |
| Example 10 | 85 | 10 | 5 | — | — | — | 80 | 20 | — | — |
| Example 11 | 85 | 5 | 10 | — | — | — | 80 | 20 | — | — |
| Example 12 | 88 | 10 | 2 | — | — | — | 90 | 10 | — | — |
| Example 13 | 87 | 10 | 3 | — | — | — | 90 | 10 | — | — |
| Example 14 | 65 | 30 | 5 | — | — | — | 90 | 10 | — | — |
| Example 15 | 93 | — | 5 | — | 2 | — | 90 | — | 10 | — |
| Comparative | 90 | — | — | — | — | 10 | — | 100 | — | — |
| Example 1 | | | | | | | | | | |
| Comparative | 90 | — | 10 | — | — | — | 90 | 10 | — | — |
| Example 2 | | | | | | | | | | |
| Comparative | 85 | — | 5 | 10 | — | — | — | — | — | 100 |
| Example 3 | | | | | | | | | | |
| Comparative | 95 | — | 5 | — | — | — | 90 | 10 | — | — |
| Example 4 | | | | | | | | | | |
| Comparative | 100 | — | — | — | — | — | 99 | — | 1 | — |
| Example 5 | | | | | | | | | | |
| Comparative | 90 | 10 | — | — | — | — | 90 | 10 | — | — |
| Example 6 | | | | | | | | | | |

TABLE 2

| | Thickness of | Internal | | | Peel | |
|---|---|---|---|---|---|---|
| | polyimide film | stress | CTE | TD1 | strength | Storage |
| | [μm] | [MPa] | [ppm/K] | [° C.] | [N/cm] | stability |
| Example 1 | 6 | 7 | 6 | 540 | 0.15 | A |
| Example 2 | 6 | 8 | 6 | 497 | 0.15 | A |
| Example 3 | 6 | 18 | 13 | 479 | 0.32 | A |
| Example 4 | 6 | 7 | 8 | 499 | 0.13 | A |
| Example 5 | 6 | 10 | 7 | 530 | 0.12 | A |
| Example 6 | 6 | 7 | 4 | 529 | 0.14 | A |
| Example 7 | 6 | 9 | 5 | 529 | 0.14 | A |
| Example 8 | 6 | 7 | 7 | 539 | 0.30 | A |
| Example 9 | 5 | 1 | 3 | 532 | 0.13 | A |
| Example 10 | 5 | 12 | 5 | 531 | 0.22 | A |
| Example 11 | 6 | 1 | 4 | 518 | 0.33 | A |
| Example 12 | 6 | 12 | 5 | 525 | 0.19 | A |
| Example 13 | 4 | 3 | 4 | 529 | 0.21 | A |
| Example 14 | 6 | 21 | 19 | 509 | 0.62 | A |
| Example 15 | 6 | 10 | 7 | 551 | 0.12 | A |
| Comparative | 6 | 8 | 5 | 529 | 0.24 | B |
| Example 1 | | | | | | |
| Comparative | 6 | 1 | 4 | 526 | 0.12 | B |
| Example 2 | | | | | | |
| Comparative | 6 | 26 | 6 | 512 | 1.44 | B |
| Example 3 | | | | | | |
| Comparative | 6 | 3 | 1 | 543 | 0.10 | B |
| Example 4 | | | | | | |
| Comparative | 6 | 2 | 3 | 578 | — | B |
| Example 5 | | | | | | |
| Comparative | 6 | 7 | 4 | 534 | — | B |
| Example 6 | | | | | | |

As shown in Table 1, in Examples 1 to 15, the polyamic acid in the prepared polyamic acid composition had a BPDA residue, an SFDA residue, a PDA residue, an ester bond-containing residue, and a diphenyl ether structure-containing residue.

As shown in Table 2, in Examples 1 to 15, the TD1 was 450° C. or higher. Thus, the polyimides obtained in Examples 1 to 15 were excellent in heat resistance. In Examples 1 to 15, the peel strength was 0.10 N/cm or more. Thus, the polyimide films obtained in Examples 1 to 15 were excellent in adhesion to an inorganic oxide film. In Examples 1 to 15, the evaluation result of the storage stability was A. Thus, the polyamic acid compositions prepared in Examples 1 to 15 were excellent in storage stability.

As shown in Table 1, in Comparative Examples 1, 5, and 6, the polyamic acid in the prepared polyamic acid composition did not have an SFDA residue. In Comparative Examples 1 and 3, the polyamic acid in the prepared polyamic acid composition did not have a PDA residue. In Comparative Example 5, the polyamic acid in the prepared polyamic acid composition did not have an ester bond-containing residue. In Comparative Examples 1 to 4, the polyamic acid in the prepared polyamic acid composition did not have a diphenyl ether structure-containing residue.

As shown in Table 2, in Comparative Examples 5 and 6, floating occurred at the interface between the polyimide film and the SiOx film. Thus, the polyimide films obtained in Comparative Examples 5 and 6 were not excellent in adhesion to an inorganic oxide film. In Comparative Examples 1 to 6, the evaluation result of the storage stability was B. Thus, the polyamic acid compositions prepared in Comparative Examples 1 to 6 were not excellent in storage stability.

The above results show that according to one or more embodiments of the present invention, it is possible to provide a polyamic acid composition that enables production of a polyimide excellent in heat resistance and adhesion to an inorganic oxide film while achieving excellent storage stability.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A polyamic acid composition comprising:
a polyamic acid; and
an organic solvent,
wherein the polyamic acid includes a tetracarboxylic dianhydride residue and a diamine residue,
the tetracarboxylic dianhydride residue includes a 3,3′,4,4′-biphenyltetracarboxylic dianhydride residue and a spiro[11H-difuro[3,4-b:3′,4′-i]xanthene-11,9′-[9H]fluorene]-1,3,7,9-tetrone residue,
the diamine residue includes a p-phenylenediamine residue,
at least one of the tetracarboxylic dianhydride residue or the diamine residue further includes a residue having an ester bond, and
at least one of the tetracarboxylic dianhydride residue or the diamine residue further includes a residue having a diphenyl ether structure.

2. The polyamic acid composition according to claim 1, wherein a content of the spiro[11H-difuro[3,4-b:3′,4′-i]xanthene-11,9′-[9H]fluorene]-1,3,7,9-tetrone residue is 10 mol % or less with respect to a total amount of the tetracarboxylic dianhydride residue included in the polyamic acid.

3. The polyamic acid composition according to claim 1, wherein the tetracarboxylic dianhydride residue includes, as the residue having the ester bond, one or more selected from the group consisting of tetravalent organic groups represented by General Formula (1) described below and a tetravalent organic group represented by Chemical Formula (2) described below:
[the General Formula (1) and the Chemical Formula (2)] 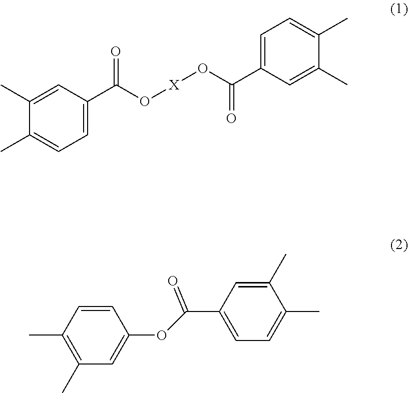
wherein X represents a divalent organic group represented by General Formula (3), a divalent organic group represented by General Formula (4), a divalent organic group represented by General Formula (5), a divalent organic group represented by Chemical Formula (6), or a divalent organic group represented by Chemical Formula (7):
[the General Formulas (3) to (5) and the Chemical Formulas (6) and (7)] 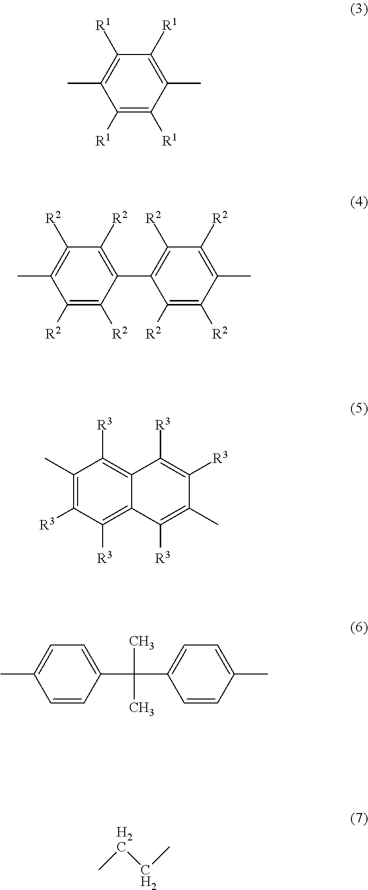
wherein R, R², and R³ each independently represent a hydrogen atom, a methyl group, an ethyl group, or a trifluoromethyl group, a plurality of R¹s are optionally equal to or different from each other, a plurality of R²s are optionally equal to or different from each other, and a plurality of R³s are optionally equal to or different from each other.

4. The polyamic acid composition according to claim 1, wherein the diamine residue includes, as the residue having the ester bond, one or more selected from the group consisting of a divalent organic group represented by Chemical Formula (8), divalent organic groups represented by General Formula (9), and divalent organic groups represented by General Formula (10):
[the Chemical Formula (8) and the General Formulas (9) and (10)] 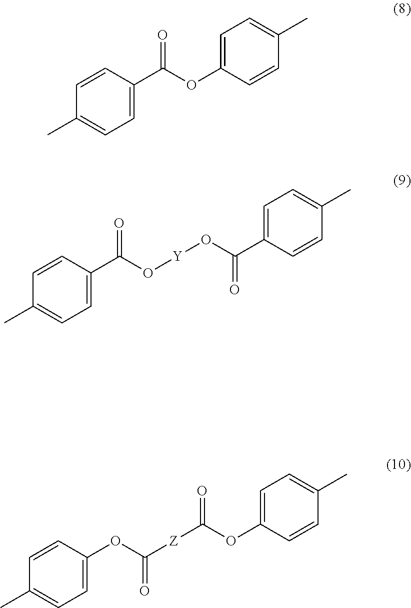
wherein Y and Z each independently represent a divalent organic group represented by General Formula (11), a divalent organic group represented by General Formula (12), or a divalent organic group represented by General Formula (13):
[the General Formulas (11) to (13)] 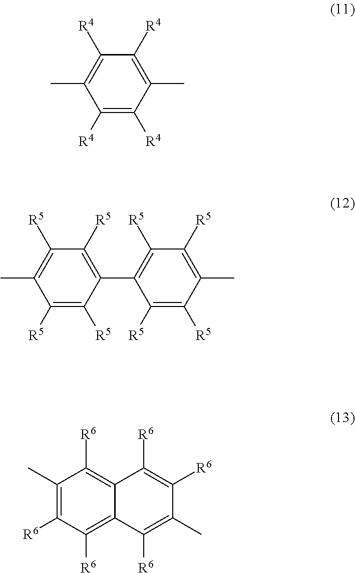
wherein R⁴, R⁵, and R⁶ each independently represent a hydrogen atom, a methyl group, an ethyl group, or a trifluoromethyl group, a plurality of R⁴s are optionally equal to or different from each other, a plurality of R⁵s are optionally equal to or different from each other, and a plurality of R⁶s are optionally equal to or different from each other.

5. The polyamic acid composition according to claim 1, wherein the tetracarboxylic dianhydride residue includes a 4,4′-oxydiphthalic anhydride residue as the residue having the diphenyl ether structure.

6. The polyamic acid composition according to claim 1, wherein the diamine residue includes a 4,4′-oxydianiline residue as the residue having the diphenyl ether structure.

7. The polyamic acid composition according to claim 4, wherein the diamine residue includes the divalent organic group represented by the Chemical Formula (8) as the residue having the ester bond.

8. The polyamic acid composition according to claim 1, having a viscosity change ratio within ±20% when stored for 14 days in an environment at a temperature of 23° C. and a relative humidity of 55%.

9. The polyamic acid composition according to claim 1, wherein the organic solvent contains a compound represented by General Formula (14):
[the General Formula (14)] 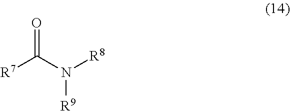
wherein R⁷, R⁸, and R⁹ each independently represent a monovalent organic group having 1 or more carbon atoms or represent a hydrogen atom, and
at least one of R⁷, R⁸, or R⁹ represents a monovalent organic group having 2 or more carbon atoms.

10. A polyimide is an imidized product of the polyamic acid contained in the polyamic acid composition according to claim 1.

11. The polyimide according to claim 10, having a 1% weight loss temperature of 450° C. or higher.

12. A polyimide film comprising the polyimide according to claim 10.

13. A laminate comprising:
a support; and
the polyimide film according to claim 12.

14. The laminate according to claim 13, further comprising an inorganic oxide film interposed between the support and the polyimide film, wherein a peel strength between the polyimide film and the inorganic oxide film is 0.10 N/cm or more.

15. An electronic device comprising:
the polyimide film according to claim 12; and
an electronic element disposed on the polyimide film.

16. A method of producing a polyimide, comprising imidizing the polyamic acid contained in the polyamic acid composition according to claim 1.

17. A method of producing a laminate including a support and a polyimide film, the method comprising:
applying the polyamic acid composition according to claim 1 onto a support to form a coating film containing the polyamic acid; and
heating the coating film to imidize the polyamic acid.

18. A method of producing an electronic device, comprising:
forming the laminate including the support and the polyimide film with the method according to claim 17; and
forming an electronic element on the polyimide film.
